(19) United States
(12) Patent Application Publication
(10) Pub. No.: US 2025/0322528 A1
(43) Pub. Date: Oct. 16, 2025

(54) GENERATING HIERARCHICAL ENTITY SEGMENTATIONS UTILIZING SELF-SUPERVISED MACHINE LEARNING MODELS

(71) Applicant: Adobe Inc., San Jose, CA (US)

(72) Inventors: Jiuxiang Gu, College Park, MD (US); Jason Wen Yong Kuen, Santa Clara, CA (US); Hao Tan, San Jose, CA (US); Ruiyi Zhang, San Jose, CA (US); Handong Zhao, San Jose, CA (US); Ani Nenkova, Philadelphia, PA (US); Tong Sun, San Jose, CA (US); Shengcao Cao, Champaign, IL (US)

(21) Appl. No.: 18/632,933

(22) Filed: Apr. 11, 2024

(51) Int. Cl. G06T 7/12; G06V 10/44; G06V 10/762; G06V 20/70

(52) U.S. Cl. CPC G06T 7/12; G06V 10/44; G06V 10/762; G06V 20/70; G06T 2207/20084; G06T 2207/20132

(57) ABSTRACT

The present disclosure relates to systems, non-transitory computer-readable media, and methods for hierarchical entity segmentation. In particular, in one or more embodiments, the disclosed systems receive a digital image comprising a plurality of object entities. In addition, in some embodiments, the disclosed systems generate, utilizing a segmentation model comprising parameters generated according to pseudo-labels indicating hierarchies of segmentation masks for a set of training digital images, a hierarchical segmentation indicating hierarchical relations of the plurality of object entities of the digital image. Moreover, in some embodiments, the disclosed systems generate, for the digital image, a segmentation map from the hierarchical segmentation of the plurality of object entities.

### BACKGROUND

Recent years have seen a growth in demand for systems that perform entity segmentation for digital images. For instance, digital device users interacting with digital media often desire to edit a specific portion (e.g., an object or a selected region) of a digital image or use portions of the digital image to edit another digital image. Segmenting digital images is frequently a challenging task for computing systems to accurately perform, especially for complex digital images with many different types of entities and parts of entities. Additionally, performing open-world entity segmentation introduces additional difficulties by attempting to segment entities in digital images (e.g., both countable objects and amorphous objects/regions) without being restricted to pre-defined classes. Existing systems are limited in the accuracy and efficiency of entity segmentation, particularly in open-world entity segmentation scenarios.

### BRIEF SUMMARY

Embodiments of the present disclosure provide benefits and/or solve one or more problems in the art with systems, non-transitory computer-readable media, and methods for hierarchical entity segmentation. In some embodiments, the disclosed systems train and utilize a self-supervised open-world segmentation model to generate hierarchical segmentations indicating hierarchical relations of object entities of a digital image. For example, in some implementations, the disclosed systems utilize a pre-trained self-supervised model to generate pseudo-labels for unlabeled digital images in a self-exploration phase. In addition, in some embodiments, the disclosed systems train a segmentation model in a self-instruction phase to learn from the pseudo-labels to generate hierarchical segmentations for object entities. Moreover, in some implementations, the disclosed systems improve the segmentation model by training a teacher-student segmentation model in a self-correction phase. Through some or all of these phases of hierarchical entity segmentation, in some embodiments, the disclosed systems generate segmentations for image entities that include indications of hierarchical relations.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a hierarchical segmentation system operates in accordance with one or more embodiments.

FIG. 2 illustrates phases for training neural networks to generate hierarchical entity segmentation of digital images in accordance with one or more embodiments.

FIG. 3 illustrates a self-exploration phase for hierarchical entity segmentation in accordance with one or more embodiments.

FIG. 4 illustrates a self-instruction phase for hierarchical entity segmentation in accordance with one or more embodiments.

FIG. 5 illustrates the hierarchical segmentation system utilizing an ancestor prediction head to generate hierarchical relations of masks in accordance with one or more embodiments.

FIG. 6 illustrates a self-correction phase for hierarchical entity segmentation in accordance with one or more embodiments.

FIG. 7 illustrates the hierarchical segmentation system providing hierarchical segmentations for display via a client device in accordance with one or more embodiments.

FIG. 8 illustrates a diagram of an example architecture of the hierarchical segmentation system in accordance with one or more embodiments.

FIG. 9 illustrates a flowchart of a series of acts for hierarchical entity segmentation in accordance with one or more embodiments.

FIG. 10 illustrates a block diagram of an example computing device for implementing one or more embodiments of the present disclosure.

### DETAILED DESCRIPTION

Open-world entity segmentation, as an emerging computer vision task, aims at segmenting entities in digital images without the restrictions of pre-defined classes. This disclosure describes one or more embodiments of a hierarchical segmentation system that offers generalization of segmentation capabilities on unseen images and concepts across domains utilizing a self-supervised segmentation model. Moreover, the hierarchical segmentation system provides novel techniques for segmenting entities in digital images while discerning hierarchical relational information in the entities. By segmenting digital images with an understanding of hierarchical relationships between entities in open-world entity segmentation tasks, the hierarchical segmentation system provides improved segmentation masks for a variety of image processing tasks.

In some embodiments, the hierarchical segmentation system trains and utilizes one or more segmentation models that generate hierarchical segmentations for object entities portrayed in digital images, including hierarchical relations of the object entities. For example, in some implementations, the hierarchical segmentation system performs a self-exploration phase utilizing an encoder neural network to generate pseudo-labels for unlabeled digital images through visual feature clustering. Additionally, in a self-instruction phase, the hierarchical segmentation system utilizes the pseudo-labels as supervision signals to train a segmentation model to generate hierarchical segmentations for object entities. Moreover, in some implementations, the hierarchical segmentation system performs a self-correction phase to improve the segmentation model by training a teacher-student segmentation model to generate hierarchical segmentations while rectifying noises in pseudo-labels.

Through hierarchical entity segmentation, the hierarchical segmentation system implements image segmentation that reflects hierarchical relationships of object entities in the digital images. Thus, beyond segmenting entities, the hierarchical segmentation system also captures their constituent parts, providing a hierarchical understanding of visual entities. Using unlabeled raw images as the sole training data, the hierarchical segmentation system achieves improved performance in image processing neural networks for self-supervised open-world hierarchical entity segmentation.

Although existing systems are able to segment object entities in digital images, such systems have a number of problems in relation to accuracy and flexibility of operation. For instance, existing systems often inaccurately segment digital images by focusing on the most prominent object in a digital image, while ignoring other objects in the digital image. Thus, existing systems often miss entities in the digital image for segmentation, which leads to inaccurate results in downstream image processing tasks.

In addition, existing systems segment objects in digital images without capturing hierarchical relational information. For example, existing systems segment entity parts and subparts as separate entities, without including the parts or subparts within the segmentations of their ancestral entities. Thus, existing systems miss the ancestral relationships that often are an important aspect of object entities depicted in digital images.

Moreover, existing systems often require extensive annotation information in training data. For instance, existing segmentation systems need to learn from training images with annotations describing object entities depicted in the training images. Furthermore, the necessary annotation data often requires a significant amount of time and many computing systems (e.g., operated by many different users) to collect the annotation information, and increases data storage requirements for the training data.

The hierarchical segmentation system provides a variety of technical advantages relative to existing systems. For example, by generating pseudo-labels including hierarchical relationships between entities of digital images to train a segmentation model, the hierarchical segmentation system improves accuracy relative to existing systems. Specifically, by clustering pixel regions with similar features to identify separate and/or related entities in a digital image during the self-exploration phase, the hierarchical segmentation system focuses on all entities in the digital image without relying on pre-defined classes of entities, rather than merely the most prominent entities. Thus, the hierarchical segmentation system captures more entities-including more small entities—than existing systems. In some cases, the hierarchical segmentation system generates many (e.g., 100+) different high-quality segmentation masks per digital image utilizing clustering of self-supervised features.

Additionally, the hierarchical segmentation system provides improved flexibility and accuracy of segmentation operations, and thus downstream tasks, by determining hierarchical relational information in entity segmentations. For example, the hierarchical segmentation system generates segmentation masks tied with relational information of ancestors and/or descendants of entities within a digital image. In some embodiments, the hierarchical segmentation system generates a segmentation map that includes both segmentation masks and indicators of hierarchical relations among the segmentation masks. This hierarchical segmentation approach provides a multi-granularity analysis of visual entities in complex scenes.

Moreover, the hierarchical segmentation system provides hierarchical segmentations for digital images without the need for annotation data in the training images. To illustrate, the hierarchical segmentation system utilizes a pre-trained encoder neural network to extract features of unlabeled training images, from which the hierarchical segmentation system clusters pixels with similar features and determines hierarchical information for the clusters. The hierarchical segmentation system utilizes the extracted features to generate pseudo-labels indicating hierarchical segmentations of entities in digital images to use as ground-truth data for training a segmentation model. Thus, the hierarchical segmentation system generates and curates a training dataset (including the pseudo-labels) for the segmentation model without a need for previously annotated data.

Furthermore, the hierarchical segmentation system provides additional accuracy and flexibility in a segmentation model by utilizing a teacher-student mutual-learning framework to rectify noises in the pseudo-labels. For instance, the hierarchical segmentation system trains a teacher-student segmentation model utilizing the segmentation model and the pseudo-labels to improve the segmentation model. Thus, the hierarchical segmentation system leverages pseudo-labels that include hierarchical segmentation data from a set of training images in conjunction with the teacher-student mutual-learning framework to adapt the segmentation model to open-world entity segmentation tasks.

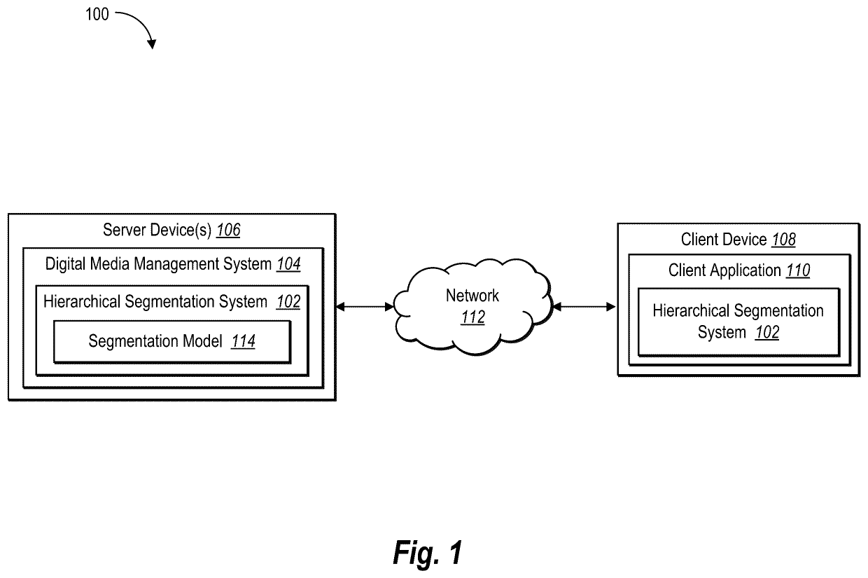

Additional detail will now be provided in relation to illustrative figures portraying example embodiments and implementations of a hierarchical segmentation system. For example, FIG. 1 illustrates a system 100 (or environment) in which a hierarchical segmentation system 102 operates in accordance with one or more embodiments. As illustrated, the system 100 includes server device(s) 106, a network 112, and a client device 108. As further illustrated, the server device(s) 106 and the client device 108 communicate with one another via the network 112.

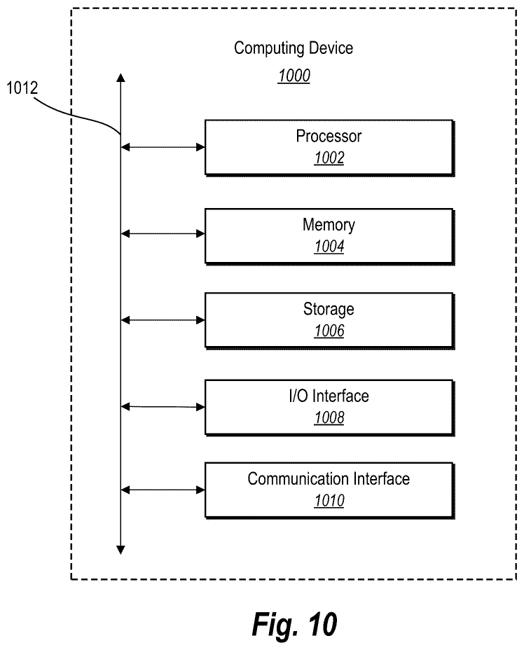

As shown in FIG. 1, the server device(s) 106 includes a digital media management system 104 that further includes the hierarchical segmentation system 102. In some embodiments, the hierarchical segmentation system 102 generates a hierarchical segmentation for a digital image, the hierarchical segmentation indicating hierarchical relations of object entities of the digital image. In some embodiments, the hierarchical segmentation system 102 utilizes a machine learning model (such as a segmentation model 114) to generate the hierarchical segmentation. In some embodiments, the server device(s) 106 includes, but is not limited to, a computing device (such as explained below with reference to FIG. 10).

In some instances, the hierarchical segmentation system 102 receives a request (e.g., from the client device 108) to generate a segmentation map for a digital image. For example, the hierarchical segmentation system 102 receives the digital image with a request to segment the digital image and, in response to the request to segment the digital image, generates a hierarchical segmentation indicating hierarchical relations of object entities (e.g., countable or non-countable objects) portrayed in the digital image in an open-world entity segmentation operation. Some embodiments of server device(s) 106 perform a variety of functions via the digital media management system 104 on the server device(s) 106. To illustrate, the server device(s) 106 (through the hierarchical segmentation system 102 on the digital media management system 104) performs functions such as, but not limited to, generating predicted segmentation masks for the object entities, predicting hierarchical relations among the predicted segmentation masks, and generating a segmentation map from the predicted segmentation masks and the predicted hierarchical relations. In some embodiments, the server device(s) 106 utilizes the segmentation model 114 to generate the predicted segmentation masks and the predicted hierarchical relations. In some embodiments, the server device(s) 106 trains the segmentation model 114.

Furthermore, as shown in FIG. 1, the system 100 includes the client device 108. In some embodiments, the client device 108 includes, but is not limited to, a mobile device (e.g., a smartphone, a tablet), a laptop computer, a desktop computer, or any other type of computing device, including those explained below with reference to FIG. 10. Some embodiments of client device 108 perform a variety of functions via a client application 110 on client device 108. For example, the client device 108 (through the client application 110) performs functions such as, but not limited to, generating predicted segmentation masks for object entities of a digital image, predicting hierarchical relations among the predicted segmentation masks, and generating a segmentation map from the predicted segmentation masks and the predicted hierarchical relations. In some embodiments, the client device 108 utilizes the segmentation model 114 to generate the predicted segmentation masks and the predicted hierarchical relations. In some embodiments, the client device 108 trains the segmentation model 114.

To access the functionalities of the hierarchical segmentation system 102 (as described above and in greater detail below), in one or more embodiments, a user interacts with the client application 110 on the client device 108. For example, the client application 110 includes one or more software applications (e.g., to interact with digital images in accordance with one or more embodiments described herein) installed on the client device 108, such as a digital media management application, an image editing application, and/or an image access application. In certain instances, the client application 110 is hosted on the server device(s) 106. Additionally, when hosted on the server device(s) 106, the client application 110 is accessed by the client device 108 through a web browser and/or another online interfacing platform and/or tool. Furthermore, in some embodiments, the client device 108, the server device(s) 106, or another system host one or more databases including digital data.

As illustrated in FIG. 1, in some embodiments, the hierarchical segmentation system 102 is hosted by the client application 110 on the client device 108 (e.g., additionally, or alternatively to being hosted by the digital media management system 104 on the server device(s) 106). For example, the hierarchical segmentation system 102 performs the hierarchical segmentation techniques described herein on the client device 108. In some implementations, the hierarchical segmentation system 102 utilizes the server device(s) 106 to train and implement machine learning models (such as the segmentation model 114). In one or more embodiments, the hierarchical segmentation system 102 utilizes the server device(s) 106 to train machine learning models (such as the segmentation model 114) and utilizes the client device 108 to implement or apply the machine learning models.

Further, although FIG. 1 illustrates the hierarchical segmentation system 102 being implemented by a particular component and/or device within the system 100 (e.g., the server device(s) 106 and/or the client device 108), in some embodiments the hierarchical segmentation system 102 is implemented, in whole or in part, by other computing devices and/or components in the system 100. For instance, in some embodiments, the hierarchical segmentation system 102 is implemented on another client device. More specifically, in one or more embodiments, the description of (and acts performed by) the hierarchical segmentation system 102 are implemented by (or performed by) the client application 110 on another client device.

In some embodiments, the client application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., a digital image and/or a segmentation request). In response, the hierarchical segmentation system 102 on the server device(s) 106 performs operations described herein to generate a hierarchical segmentation map for the digital image. The server device(s) 106 provides the output or results of the operations (e.g., a segmentation map with indications of hierarchical relations) to the client device 108. As another example, in some implementations, the hierarchical segmentation system 102 on the client device 108 performs operations described herein to generate a hierarchical segmentation map for the digital image. The client device 108 provides the output or results of the operations (e.g., a segmentation map with indications of hierarchical relations) via a display of the client device 108, and/or transmits the output or results of the operations to another device (e.g., the server device(s) 106 and/or another client device).

Additionally, as shown in FIG. 1, the system 100 includes the network 112. As mentioned above, in some instances, the network 112 enables communication between components of the system 100. In certain embodiments, the network 112 includes a suitable network and communicates using any communication platforms and technologies suitable for transporting data and/or communication signals, examples of which are described with reference to FIG. 10. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

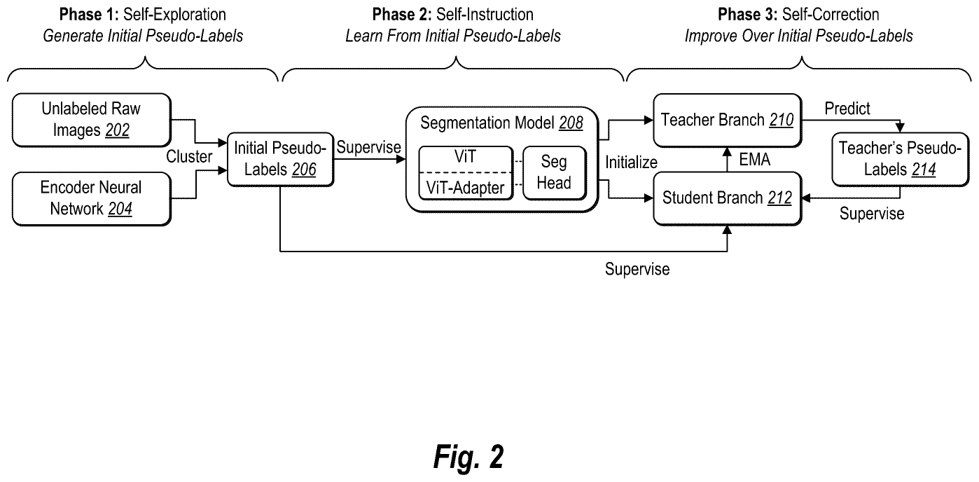

As mentioned, in some embodiments, the hierarchical segmentation system 102 generates hierarchical segmentations indicating hierarchical relations of object entities of a digital image. Additionally, in some embodiments, the hierarchical segmentation system 102 trains a segmentation model and utilizes the segmentation model to generate the hierarchical segmentations. For instance, FIG. 2 illustrates the hierarchical segmentation system 102 training and utilizing a segmentation model in accordance with one or more embodiments.

Specifically, FIG. 2 shows a three-phased approach to training and utilizing a segmentation model to generate hierarchical segmentations. To illustrate, in a first phase, the hierarchical segmentation system 102 uses self-exploration to generate initial pseudo-labels; in a second phase, the hierarchical segmentation system 102 uses self-instruction to learn from the initial pseudo-labels; and in a third phase, the hierarchical segmentation system 102 uses self-correction to improve over the initial pseudo-labels.

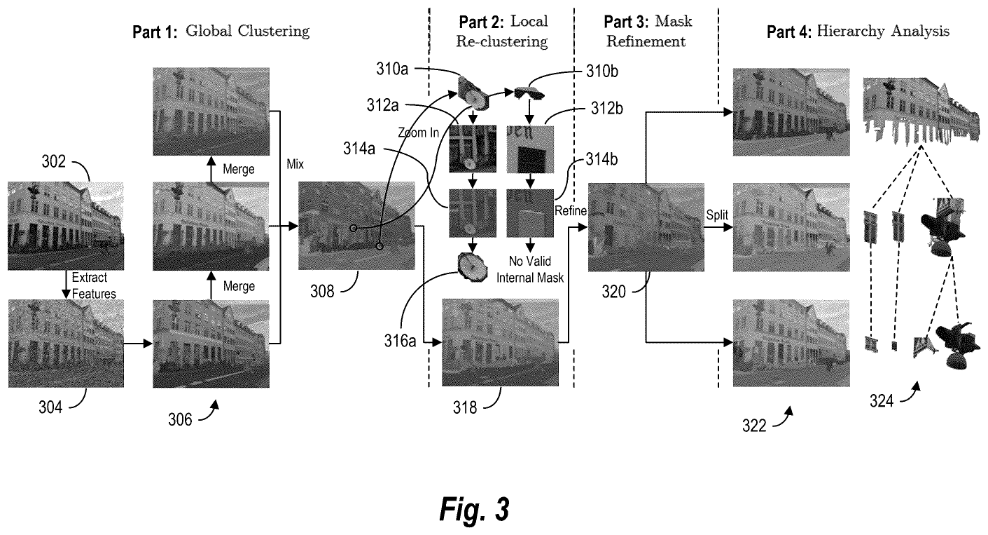

More particularly, in the first phase, in some embodiments, the hierarchical segmentation system 102 obtains a set of unlabeled raw digital images 202 and utilizes an encoder neural network 204 to extract features of the raw digital images. In some implementations, the encoder neural network 204 includes a pre-trained self-supervised representation, such as a neural network with a vision transformer architecture. Additionally, in some embodiments, the hierarchical segmentation system 102 utilizes agglomerative clustering to organize image patches into semantically consistent regions and generate initial pseudo-labels 206 for the raw digital images, as described in additional detail below in connection with FIG. 3.

In addition, in the second phase, in some embodiments, the hierarchical segmentation system 102 utilizes the initial pseudo-labels 206 to train a segmentation model 208 (similar to or the same as segmentation model 114). In some implementations, the segmentation model 208 includes a pre-trained vision transformer backbone (e.g., similar to the encoder neural network 204), a vision transformer adapter (e.g., for generating multi-scale features), and a mask transformer (e.g., for predicting segmentation masks). Moreover, the hierarchical segmentation system 102 utilizes self-supervised instruction to learn from common visual entities in different images and generalize information contained in the initial pseudo-labels 206. For example, the hierarchical segmentation system 102 utilizes the segmentation model 208 to generate a hierarchical segmentation indicating hierarchical relations of a plurality of object entities of a digital image. Furthermore, in some implementations, the hierarchical segmentation system 102 generates a segmentation map from the hierarchical segmentation of the plurality of object entities.

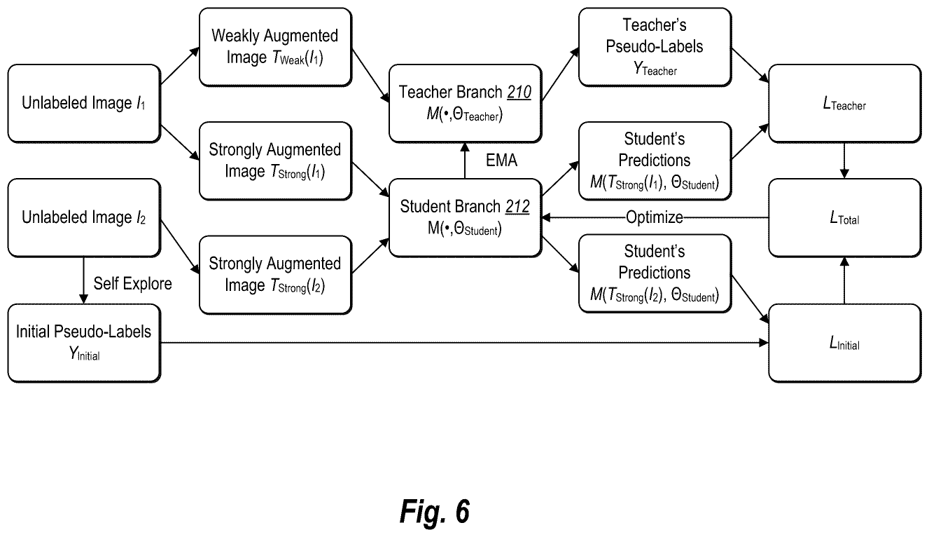

Furthermore, in the third phase, in some embodiments, the hierarchical segmentation system 102 employs a teacher-student mutual-learning framework in a self-supervised fashion to improve over the segmentation model 208. For instance, the hierarchical segmentation system 102 initializes a teacher branch 210 and a student branch 212 of a teacher-student segmentation model with parameters of the segmentation model 208. As described in further detail below in connection with FIG. 6, the hierarchical segmentation system 102 utilizes the teacher branch 210 to predict teacher pseudo-labels 214, and utilizes the teacher pseudo-labels 214 and the initial pseudo-labels 206 to supervise learning of the student branch 212. In some implementations, the hierarchical segmentation system 102 updates parameters of the student branch 212 utilizing an optimization algorithm, and updates parameters of the teacher branch 210 utilizing a moving average of the parameters of the student branch 212.

As discussed above, in some embodiments, the hierarchical segmentation system 102 generates initial pseudo-labels in a self-exploration phase of hierarchical entity segmentation. For instance, FIG. 3 illustrates the hierarchical segmentation system 102 clustering features of a digital image and determining hierarchical relations to generate pseudo-labels in accordance with one or more embodiments.

Specifically, FIG. 3 shows four parts of the self-exploration phase. To illustrate, in the first part, the hierarchical segmentation system 102 uses global clustering to merge patches of pixels into semantically meaningful candidate regions based on visual features; in the second part, the hierarchical segmentation system 102 uses local clustering to investigate the candidate regions to discover small entities to add to the pool of candidate regions; in the third part, the hierarchical segmentation system 102 uses mask refinement to refine the candidate regions into initial masks; and in the fourth part, the hierarchical segmentation system 102 uses hierarchy analysis to determine hierarchical relations among the initial masks, thereby generating initial pseudo-labels (or pseudo-labels) for use in the self-instruction and/or self-correction phases. In some implementations, more or fewer parts are included in the self-exploration phase. For example, in some implementations, the hierarchical segmentation system 102 omits mask refinement from the self-exploration phase.

As used herein, a pseudo-label (or initial pseudo-label) includes a segmentation mask accompanied or tagged with information indicating a hierarchical relation of the segmentation mask. For example, a pseudo-label includes a segmentation mask for an object entity with a machine-generated annotation, the annotation comprising information about the mask's hierarchical properties in a hierarchy of object entities. In some implementations, the hierarchical segmentation system 102 utilizes the pseudo-labels as supervision signals for training the segmentation model 208 and/or the student branch 212 of the teacher-student segmentation model.

More particularly, in the global clustering part of self-exploration, in some embodiments, the hierarchical segmentation system 102 obtains (e.g., receives) a digital image 302 that portrays object entities. In some embodiments, object entities include people or other countable things depicted in a digital image, such as one or more subjects and/or one or more objects. In some cases, an object entity is an animate object shown in the digital image, while in some other cases, an object entity is an inanimate object shown in the digital image. In additional embodiments, object entities include non-countable objects in a digital image such as amorphous objects like the sky, terrain, etc. Moreover, object entities include whole entities, part entities, and subpart entities. For example, a digital image includes an automobile with wheels and rubber tires, where the automobile is a whole, a wheel is a part, and a rubber tire on the wheel is a subpart.

In some embodiments, the hierarchical segmentation system 102 utilizes an encoder neural network to extract features 304 representing the digital image 302. For example, the hierarchical segmentation system 102 extracts feature vectors for the digital image 302.

A neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

Relatedly, a machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

As just mentioned, in some implementations, the hierarchical segmentation system 102 extracts features for the digital image 302. In some embodiments, the hierarchical segmentation system 102 utilizes a pre-trained encoder neural network to extract the features 304, such as a vision-transformer based encoder neural network. In one or more embodiments, the pre-trained encoder neural network utilizes self-distillation with no labels, as described by Caron et al. in Emerging Properties in Self-Supervised Vision Transformers, ICCV 2021, which is herein incorporated by reference in its entirety. In additional embodiments, the pre-trained encoder includes a one or more additional encoder neural networks that extract features of a digital image in a patch-based encoding process.

To further illustrate, in some cases, the hierarchical segmentation system 102 determines patches of pixels within the digital image 302. For example, given the digital image 302 with a resolution S×S, the hierarchical segmentation system 102 divides the digital image 302 into patches of pixels with resolution 8×8, and extracts feature vectors

$$\{ {f}_{1} , … , {f}_{\frac{S}{8} \times \frac{S}{8}} \}$$

corresponding to each patch. For instance, the feature vector for a patch represents visual features of the pixels within the patch.

Utilizing the feature vectors, in some implementations, the hierarchical segmentation system 102 merges patches in a bottom-up, iterative manner. For instance, the hierarchical segmentation system 102 utilizes the initial patches (e.g., with resolution 8×8) as initial seed regions to iteratively pair adjacent regions with similar features. For example, the hierarchical segmentation system 102 determines, in each iteration, the pair of adjacent regions (i,j) with the highest feature similarity. For instance, the hierarchical segmentation system 102 utilizes a cosine similarity to compare features: (f₁·fⱼ)/(∥fᵢ∥₂·∥fⱼ∥₂).

In some embodiments, the hierarchical segmentation system 102 merges the two adjacent regions i,j that have the highest feature similarity into a new region k. The hierarchical segmentation system 102 determines a feature vector for the new region k as a sum of the feature vectors of the two adjacent regions: fₖ=fᵢ+fⱼ. Alternatively, in some embodiments, the hierarchical segmentation system 102 determines the feature vector for the new region k as a mean of the feature vectors of the two adjacent regions. In some embodiments, the hierarchical segmentation system 102 replaces the two adjacent regions i,j with the new region k.

Moreover, in some implementations, the hierarchical segmentation system 102 iteratively repeats this procedure to cluster the patches of pixels into candidate regions. In general, the highest feature similarity (among all unmerged region pairs) decreases as more regions are merged. In some cases, the hierarchical segmentation system 102 utilizes a series of merging thresholds θ_{merge,1}> . . . >θ_{merge,m} as a criterion for stopping the merging procedure. For example, when the highest feature similarity goes below one threshold θ_{merge,t}(t ∈{1, . . . , m}), the hierarchical segmentation system 102 records the merging results obtained to that point. In consequence, in some implementations, the hierarchical segmentation system 102 generates m sets of regions 306, covering various granularity levels. For instance, the m sets of regions 306 include different clusters of pixel patches at different merging thresholds. In some embodiments, the hierarchical segmentation system 102 utilizes predetermined merging thresholds selected based on a desired number of pseudo-labels per digital image.

Furthermore, in some implementations, the hierarchical segmentation system 102 combines the sets of regions (e.g., combines the groups of clusters) into a pool of regions 308. In some cases, some regions overlap with each other. In some implementations, the hierarchical segmentation system 102 utilizes non-maximal suppression (or another duplication detection algorithm such as other intersection over union algorithms or a neural network) to remove duplicate regions from the pool of regions 308 (or to determine a modified pool of regions without the duplicate regions).

As mentioned, in some embodiments, the hierarchical segmentation system 102 utilizes local re-clustering to identify additional regions (e.g., small regions not identified during global clustering) as candidate entities in the digital image 302 to add to the pool of candidate regions. For example, while the pool of regions 308 largely corresponds to valid entities in the digital image 302, in one or more embodiments, some of the regions are noisy and/or do not correspond to a valid entity. Thus, in some implementations, the hierarchical segmentation system 102 reexamines the regions in the pool of regions 308 that are smaller than a predetermined percentage of the whole digital image 302.

To illustrate, in some embodiments, for each small candidate region, the hierarchical segmentation system 102 crops a local image from the digital image 302, the local image being a portion of the digital image 302 that includes the small candidate region. The hierarchical segmentation system 102 resizes the local image to a resolution S′×S′ and then performs the clustering procedure described above in connection with global clustering. For example, the hierarchical segmentation system 102 determines subregions for the local image by merging patches of the local image that have feature similarities. Thus, the hierarchical segmentation system 102 merges the patches within the local image into a reclustered pool of regions based on similarities of their feature vectors. In some embodiments, the hierarchical segmentation system 102 only considers subregions that are strictly inside the small candidate region.

To further illustrate, as shown in FIG. 3, the hierarchical segmentation system 102 determines small candidate regions 310a, 310b from the pool of regions 308. The small candidate regions 310a, 310b correspond to small entities depicted in the digital image 302. The hierarchical segmentation system 102 crops local images 312a, 312b that correspond, respectively, to the small candidate regions 310a, 310b. The hierarchical segmentation system 102 performs the iterative merging procedure on the local images 312a, 312b to generate local pools of regions 314a, 314b that correspond, respectively, to the local images 312a, 312b. In some cases, a local pool of regions does not include a valid internal mask because the corresponding local image does not depict a valid entity (e.g., the local image does not depict a full entity, whether the full entity be a whole, a part, or a subpart).

For example, in FIG. 3, the hierarchical segmentation system 102 determines that the local pool of regions 314b does not include a valid internal mask, whereas the local pool of regions 314a does. The hierarchical segmentation system 102 thus determines a subregion 316a from the local pool of regions 314a. The hierarchical segmentation system 102 adds the subregion 316a (and other subregions determined through this procedure) to the pool of regions 308 to generate a reclustered pool of regions 318. In some embodiments, the hierarchical segmentation system 102 utilizes the reclustered pool of regions 318 as initial segmentation masks for the initial pseudo-labels. As mentioned, in some cases, by zooming in on the small candidate regions and repeating the clustering procedure at a finer scale, the hierarchical segmentation system 102 removes noisy segmentation masks and improves the quality of the remaining segmentation masks.

As mentioned, in some embodiments, the hierarchical segmentation system 102 utilizes mask refinement to further improve the mask quality of the segmentation masks. For instance, the hierarchical segmentation system 102 refines the reclustered pool of regions 318 to generate a refined pool of regions 320. In some implementations, the hierarchical segmentation system 102 leverages a mask refinement model to boost the quality of the segmentation masks, such as the model described by Cheng, et al., in CascadePSP: Toward Class-Agnostic and Very High-Resolution Segmentation via Global and Local Refinement, CVPR 2020, which is herein incorporated by reference in its entirety. In addition, in some implementations, the hierarchical segmentation system 102 computes mask intersection-over-union (IoU) scores between the segmentation masks before and after undergoing mask refinement, and removes the masks with poor IoU scores from the refined pool of regions 320, as poor IoU scores indicate likely noisy samples.

Moreover, as mentioned, in some embodiments, the hierarchical segmentation system 102 utilizes hierarchy analysis to determine hierarchical relations among the initial segmentation masks, thereby generating pseudo-labels 322 with hierarchical structure 324 for use in the self-instruction and/or self-correction phases. As used herein, hierarchical relations include ancestor relations, sibling relations, and descendant relations. For instance, hierarchical relations indicate a relationship between segmentation masks (e.g., mask hierarchies of object entities). For example, a subpart of a part has a child-parent relationship with the part, and a part of a whole likewise has a child-parent relationship.

For instance, the hierarchical segmentation system 102 determines the hierarchical structure 324 embedded within the segmentation masks, represented as a forest structure (e.g., set of trees) where roots represent whole entities in a digital image, and descendants represent parts and subparts of entities. To illustrate, the hierarchical segmentation system 102 tests pairs of segmentation masks i,j to determine their hierarchical relationship: if greater than a threshold percentage of pixels of segmentation mask i are also in segmentation mask j (i.e., i is covered by j), and less than the threshold percentage of pixels of segmentation mask j are in segmentation mask i (i.e., j is larger than i), then segmentation mask j is an ancestor of segmentation mask i in the hierarchy forest. Moreover, the smallest ancestor of segmentation mask i is the direct parent of segmentation mask i. Thus, in some embodiments, by testing pixel coverage between segmentation masks, the hierarchical segmentation system 102 determines the hierarchical structure 324 for the segmentation masks, thereby determining the pseudo-labels 322.

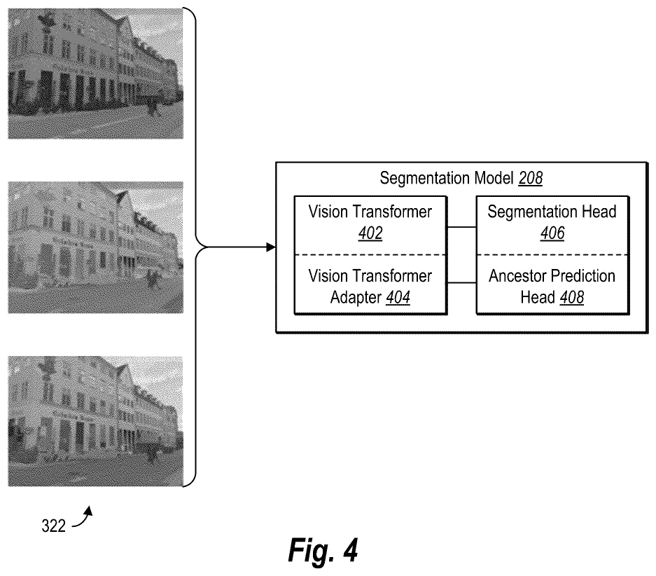

As mentioned above, in some embodiments, the hierarchical segmentation system 102 learns from the pseudo-labels in a self-instruction phase of hierarchical entity segmentation. For instance, FIG. 4 illustrates the hierarchical segmentation system 102 training the segmentation model 208 to learn and generalize from the pseudo-labels 322 in accordance with one or more embodiments. As mentioned, in some embodiments, the hierarchical segmentation system 102 mitigates potential noise in the pseudo-labels. For example, by training the segmentation model 208 to observe valid entities from the pseudo-labels that occur more frequently than noises, the hierarchical segmentation system 102 improves accuracy of segmentations of unseen images (e.g., in an open-world segmentation task).

As shown in FIG. 4, in some embodiments, the segmentation model 208 includes a vision transformer 402 as a backbone and a vision transformer adapter 404 for producing multi-scale visual feature maps. For the vision transformer 402, in some implementations, the hierarchical segmentation system 102 utilizes a vision-transformer based encoder neural network as previously described in relation to FIG. 3. In some embodiments, the vision transformer 402 is not fixed, and the hierarchical segmentation system 102 updates parameters of the vision transformer 402 during training of the segmentation model 208.

In some implementations, the hierarchical segmentation system 102 utilizes the vision transformer adapter 404 to generate multiple levels of feature maps (e.g., based on features generated by the vision transformer 402) that the segmentation head 406 uses to determine segmentation masks. For the vision transformer adapter 404, in some implementations, the hierarchical segmentation system 102 utilizes a vision transformer adapter 404 including the model described by Chen et al. in Vision Transformer Adapter for Dense Predictions, ICLR 2023, which is herein incorporated by reference in its entirety.

Additionally, in some embodiments, the segmentation model 208 includes a segmentation head 406 and an ancestor prediction head 408. In some implementations, the hierarchical segmentation system 102 utilizes the segmentation head 406 to predict segmentation masks for object entities of digital images. For the segmentation head 406, in some implementations, the hierarchical segmentation system 102 utilizes a transformer-based encoder neural network. To illustrate, in some embodiments, the hierarchical segmentation system 102 utilizes the segmentation head 406 including the model described by Cheng at al. in Masked-attention Mask Transformer for Universal Image Segmentation, CVPR 2022, which is herein incorporated by reference in its entirety.

In some implementations, the hierarchical segmentation system 102 attaches the ancestor prediction head 408 to the segmentation head 406, and utilizes the ancestor prediction head 408 to predict hierarchical relations among predicted segmentation masks. To illustrate, in some embodiments, the hierarchical segmentation system 102 utilizes the ancestor prediction head 408 in parallel with the segmentation head 406 to operate on query features.

To illustrate, in some embodiments, the hierarchical segmentation system 102 utilizes the pseudo-labels 322 as ground truth segmentation masks with hierarchy annotations to train the segmentation model 208 on a set of training digital images. For example, throughout numerous training iterations, the hierarchical segmentation system 102 modifies parameters of the segmentation model 208 to reduce a measure of loss for the segmentation model 208 to improve the hierarchical entity segmentation performed by the segmentation model 208 for subsequent iterations. For instance, the hierarchical segmentation system 102 determines the measure of loss by comparing output hierarchies of segmentation masks for the training digital images (as generated by the segmentation model 208) with the pseudo-labels 322.

As mentioned, in some embodiments, the hierarchical segmentation system 102 generates a segmentation map. For instance, the hierarchical segmentation system 102 utilizes the segmentation model 208 to generate the segmentation map by determining a predicted hierarchical segmentation of object entities of a digital image, utilizing the segmentation head 406 to predict segmentation masks for the object entities, and utilizing the ancestor prediction head 408 to predict hierarchical relations among the predicted segmentation masks of the object entities. Alternatively (or additionally), the hierarchical segmentation system 102 utilizes a teacher-student segmentation model to generate the segmentation map, as described in additional detail below.

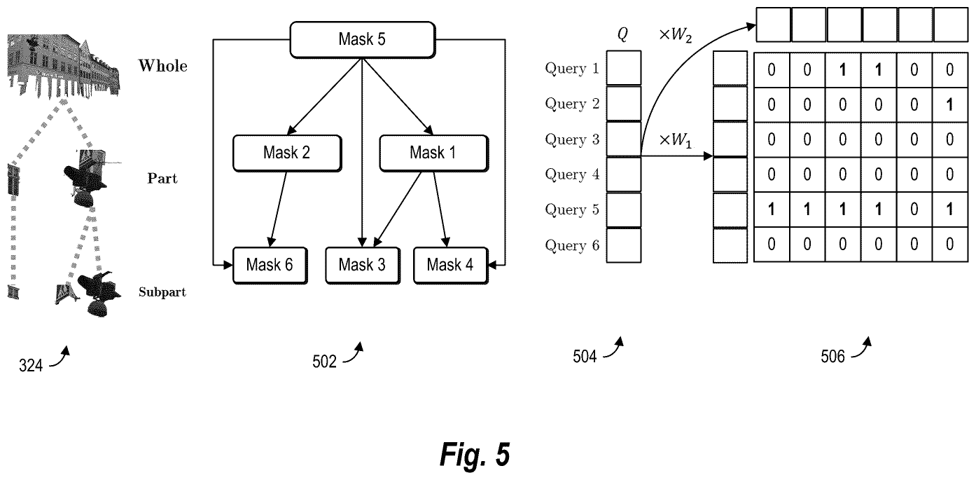

FIG. 5 illustrates the hierarchical segmentation system 102 utilizing the ancestor prediction head 408 (as described above in connection with FIG. 4) to generate linear mappings that transform query features to predicted target ancestors in accordance with one or more embodiments. More particularly, FIG. 5 shows the hierarchical segmentation system 102 utilizing the hierarchical structure 324 of the pseudo-labels 322 (described above in connection with FIG. 3) to learn parameters of the ancestor prediction head 408. For example, the hierarchical segmentation system 102 utilizes the hierarchical structure 324 to train the ancestor prediction head 408 to generate a prediction target of linear transformations for hierarchical relations of segmentation masks, and to determine the predicted hierarchical relations for the segmentation masks from the linear transformations.

To illustrate, the hierarchical segmentation system 102 utilizes the ancestor prediction head 408 to associate masks 502 of the hierarchical structure 324 with query features 504. The hierarchical segmentation system 102 generates linear transformations for the masks 502 based on the query features 504. For instance, the hierarchical segmentation system 102 generates a linear transformation matrix 506 (e.g., a binary matrix) that represents ancestor relations for the masks 502. In some embodiments, the hierarchical segmentation system 102 utilizes linear mappings to transform the query features 504 to predict the hierarchical relations. For example, as depicted in FIG. 5, the hierarchical segmentation system 102 determines an outer product of two vectors: first, the query features 504 multiplied by a first weight; and second, the query features 504 multiplied by a second weight.

To further illustrate, in some implementations, the hierarchical segmentation system 102 determines the query features 504 as Q ∈ [symbol] ^{N×C}, where N is the number of queries and C is the query feature dimension. As shown in FIG. 5, in some implementations, the hierarchical segmentation system 102 uses a learning target of the ancestor prediction as a non-symmetric binary matrix representing ancestor relations P ∈{0, 1}^{N×N}, where P_{i,j}=1 represents that mask i is an ancestor of mask j, and P_{i,j}=0 otherwise. In some cases, a mask i may have no ancestors if mask i is a whole entity (e.g., a root in the hierarchy forest). In some other cases, a mask i may have more than one ancestor if mask i is a part of another part (e.g. a deep node in the hierarchy forest). In some implementations, the hierarchical segmentation system 102 formulates the ancestor prediction as \hat{P}=sigmoid ((QW₁)(QW₂)^{T}/\vec{C}) ∈ [symbol] ^{N×N}, where W₁, W₂ ∈ [symbol] ^{C×C} are learnable weights for two linear transformations.

In some embodiments, the hierarchical segmentation system 102 uses two different linear mappings because the ancestor relations are non-symmetric. Moreover, in some embodiments, the hierarchical segmentation system 102 utilizes a binary cross-entropy (BCE) loss L_{ancestor}=BCE(\hat{P}, P) to optimize (or improve) the linear mappings. At inference time, in some implementations, the hierarchical segmentation system 102 employs topological sorting to reconstruct the forest structure from the binary ancestor relation predictions. Furthermore, in some embodiments, the hierarchical segmentation system 102 produces a variable number of hierarchical levels for the object entities, without being constrained by a pre-defined number of hierarchical levels or groups.

As mentioned, in some implementations, the initial pseudo-labels from the self-exploration phase include noise. Moreover, in the self-instruction phase, the hierarchical segmentation system 102 trains the segmentation model 208 to predict masks that are more reliable and accurate than the clustering results of pseudo-labels from the self-exploration phase. In some embodiments, the hierarchical segmentation system 102 improves the segmentation model 208 utilizing a self-correction phase.

As discussed above, in some embodiments, the hierarchical segmentation system 102 improves over the initial pseudo-labels in a self-correction phase. For instance, FIG. 6 illustrates the hierarchical segmentation system 102 employing teacher-student mutual-learning to improve over the segmentation model 208 in accordance with one or more embodiments.

Specifically, FIG. 6 shows the hierarchical segmentation system 102 utilizing a teacher-student segmentation model with the teacher branch 210 and the student branch 212. In some implementations, the hierarchical segmentation system 102 initializes the teacher branch 210 and the student branch 212 with the parameters of the segmentation model 208. For instance, the teacher branch 210 begins in the self-correction phase having the same parameters as the segmentation model 208, and the student branch 212 also begins the self-correction phase having the same parameters as the segmentation model 208.

Moreover, in some embodiments, the hierarchical segmentation system 102 utilizes the teacher branch 210 to predict a hierarchical segmentation of object entities (e.g., teacher pseudo-labels Y_{Teacher}). To illustrate, the hierarchical segmentation system 102 obtains a first unlabeled image I₁ (e.g., in a first batch of unlabeled digital images), weakly augments the first unlabeled image I₁, and processes the weakly augmented image through the teacher branch 210. In some embodiments, the hierarchical segmentation system 102 utilizes one or more of a number of weak augmentation operations. For example, the hierarchical segmentation system 102 rotates, crops, reflects, and/or dilates the digital image. By applying weak augmentation to the first unlabeled image I₁, the hierarchical segmentation system 102 increases the robustness of the teacher branch 210 to distortions in digital images. Utilizing the teacher branch 210, the hierarchical segmentation system 102 generates the teacher pseudo-labels Y_{Teacher}.

Similarly, in some embodiments, the hierarchical segmentation system 102 utilizes the student branch 212 to predict a hierarchical segmentation of object entities (e.g., student predictions). To illustrate, the hierarchical segmentation system 102 obtains a second unlabeled image I₂ (e.g., in a second batch of unlabeled digital images). The hierarchical segmentation system 102 strongly augments both the first unlabeled image I₁ and the second unlabeled image I₂, and processes the strongly augmented images through the student branch 212. In some embodiments, the hierarchical segmentation system 102 utilizes one or more of a number of strong augmentation operations. For example, the hierarchical segmentation system 102 discolors, blurs, and/or adds noise to the digital image. By applying strong augmentation to the first unlabeled image I₁ and the second unlabeled image I₂, the hierarchical segmentation system 102 increases the robustness of the student branch 212 to noisy, grainy, or unnatural digital images.

In some implementations, the hierarchical segmentation system 102 applies strong image augmentations for the student branch 212 to challenge the student branch 212 to improve its capabilities for difficult segmentation scenarios, while the hierarchical segmentation system 102 applies weak image augmentations for the teacher branch 210 to ensure the stability and reliability of the results of the teacher branch 210, which results are used to train the student branch 212.

Utilizing the student branch 212, the hierarchical segmentation system 102 generates a first and a second set of student predictions (based, respectively, on the first and second unlabeled images I₁ and I₂). Moreover, in some implementations, the hierarchical segmentation system 102 utilizes the second unlabeled image I₂ to generate initial pseudo-labels Y_{Initial} for the second unlabeled image I₂ (e.g., utilizing the techniques of the self-exploration phase described above).

With the teacher pseudo-labels and the first set of student predictions (both of which are based on the first unlabeled image I₁), the hierarchical segmentation system 102 generates a first measure of loss L_{Teacher} that reflects a segmentation loss between the teacher pseudo-labels and the student predictions. In addition, with the second set of student predictions (based on the second unlabeled image I₂) and the initial pseudo-labels for the second unlabeled image I₂, the hierarchical segmentation system 102 generates a second measure of loss L_{Initial} that reflects a segmentation loss between the student predictions and the initial pseudo-labels. In some embodiments, the segmentation loss is composed of a classification loss, a mask loss, and an ancestor prediction loss (e.g., the binary cross-entropy loss for ancestor prediction described above).

In some implementations, the hierarchical segmentation system 102 combines the first and second measures of loss into a total measure of loss for training the teacher-student segmentation model. For instance, the hierarchical segmentation system 102 sums the first and second measures of loss, and uses the resulting total loss to update parameters of the student branch 212. In some embodiments, the hierarchical segmentation system 102 optimizes (or improves) the student branch 212 utilizing an optimization routine, such as gradient descent. For instance, the hierarchical segmentation system 102 modifies the parameters of the student branch 212 to minimize (or reduce) the total loss for a subsequent iteration of training. Thus, in some embodiments, the hierarchical segmentation system 102 supervises the student branch 212 utilizing both the initial pseudo-labels and the teacher's pseudo-labels.

In addition, in some implementations, the hierarchical segmentation system 102 updates parameters of the teacher branch 210. For instance, the hierarchical segmentation system 102 modifies the parameters of the teacher branch 210 at each iteration of training according to a moving average of the parameters of the student branch 212. For instance, the hierarchical segmentation system 102 utilizes an exponential moving average of the student branch 212 to update the teacher branch 210.

Denoted symbolically, the total loss for the teacher-student segmentation model is: L_{Total}=L_{Teacher}+L_{Initial} where L_{Teacher}=L_{seg}( [symbol] ( [symbol] _{strong}(I₁), Θ_{Student}), Y_{Teacher}), L_{Initial}=L_{seg} ( [symbol] ( [symbol] _{strong}(I₂), Θ_{Student}), Y_{Initial}), I₁ and I₂ are the first and second batches of unlabeled images respectively, [symbol] (·, Θ_{Teacher}) denotes the operations of the teacher branch 210, [symbol] (·, Θ_{Student}) denotes the operations of the student branch 212, Y_{Teacher} is the pseudo-labels of the teacher branch 210 by thresholding the predictions [symbol] ( [symbol] _{weak}(I₁), Θ_{Teacher}), Initial is the initial pseudo-labels on I₂, [symbol] _{strong} and [symbol] _{weak} denote strong and weak data augmentations respectively, and L_{seg} is the segmentation loss. Furthermore, the exponential moving average is denoted symbolically as Θ_{Teacher}←mΘ_{Teacher}+(1−m)Θ_{Student}, where m ∈(0, 1) is the momentum.

In some cases, the hierarchical segmentation system 102 improves the reliability of supervision by the teacher branch predictions [symbol] ( [symbol] _{weak}(I₁), Θ_{Teacher}) by retaining, for the pseudo-labels Y_{Teacher}, only those masks with confidence scores higher than a threshold value θ_{score}. Moreover, in some cases, the hierarchical segmentation system 102 adapts the threshold value θ_{score} based on the size of the masks. For instance, if confidence scores are generally lower for segmentations of small entities, the hierarchical segmentation system 102 lowers the threshold value θ_{score} to keep the ratio of small pseudo-labels at desirable levels, thereby mitigating a risk that small entity segmentation performance (and resulting overall performance) might be impaired. For instance, the hierarchical segmentation system 102 leverages a dynamic threshold: θ_{score}=(1−(1−α)^{γ})(θ_{score,large}−θ_{score,small})+θ_{score,small}, where α∈(0, 1) is the area ratio between the predicted mask and the whole image, γ>1 is a hyper-parameter, and θ_{score,small}<θ_{score,large} are pre-set thresholds for the smallest mask and the largest mask, respectively. Utilizing this dynamic thresholding for masks of different size scales, the hierarchical segmentation system 102 balances the distribution in the teacher pseudo-labels and encourages the student branch 212 to accurately segment small entities.

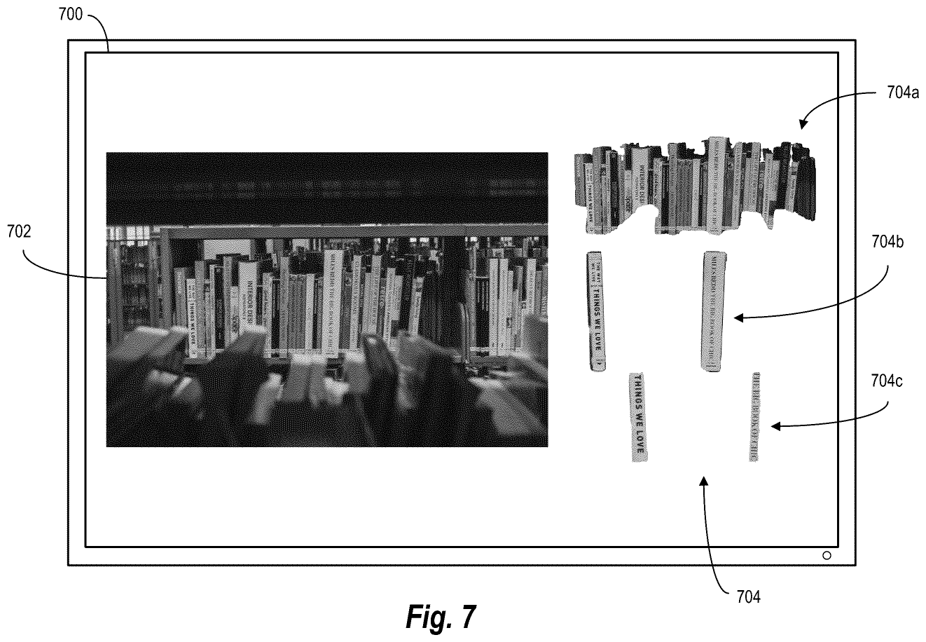

As discussed above, in some embodiments, the hierarchical segmentation system 102 generates and provides, for display, a hierarchy of segmentation masks for object entities depicted in a digital image. For instance, FIG. 7 illustrates the hierarchical segmentation system 102 providing hierarchical segmentations for display via a client device in accordance with one or more embodiments.

Specifically, FIG. 7 shows a graphical user interface 700 of a client device (e.g., the client device 108). The graphical user interface 700 displays a digital image 702 (e.g., depicting a shelf of books in a library). In some implementations, the hierarchical segmentation system 102 utilizes the techniques described above (e.g., one or more of the self-exploration phase, the self-instruction phase, and/or the self-correction phase) to train a segmentation model to generate hierarchical segmentations for the digital image 702. For example, the hierarchical segmentation system 102 utilizes the segmentation model 208 or the student branch 212 of the teacher-student segmentation model to generate predicted segmentation masks and predicted hierarchical relations for object entities in the digital image 702.

As shown in FIG. 7, the hierarchical segmentation system 102 utilizes the predicted segmentation masks and the predicted hierarchical relations to generate a hierarchy of segmentation masks 704. In some cases, the hierarchy of segmentation masks 704 has several hierarchy levels, such as a whole level 704a, a part level 704b, and a subpart level 704c. For instance, as illustrated, the hierarchical segmentation system 102 determines, from the shelf of books, a whole comprising a row of books, one or more parts comprising single books, and one or more subparts comprising titles of books.

Alternatively, or additionally, in some implementations, the hierarchical segmentation system 102 provides a segmentation map from the hierarchical segmentation of the object entities for display via the graphical user interface 700 of the client device. For example, the hierarchical segmentation system 102 provides a segmentation map of the row of books for display via the graphical user interface. In some embodiments, the hierarchical segmentation system 102 provides different segmentations for display at the client device based on user inputs to the client device. To illustrate, the client device displays an option to select a segmentation with more or less granularity (e.g., higher or lower in a hierarchical segmentation) in response to a user input (e.g., via a mouse click or wheel scroll). In response, the client device selects an object entity at the whole level 704a, the part level 704b, or the subpart level 704c according to the user input.

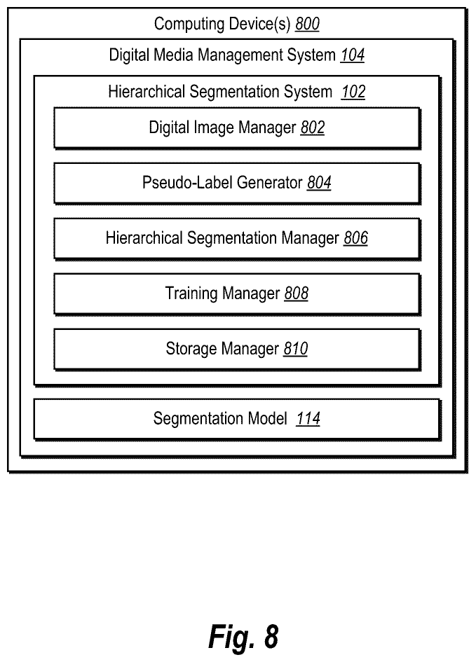

Turning now to FIG. 8, additional detail will be provided regarding components and capabilities of one or more embodiments of the hierarchical segmentation system 102. In particular, FIG. 8 illustrates an example hierarchical segmentation system 102 executed by a computing device(s) 800 (e.g., the server device(s) 106 or the client device 108). As shown by the embodiment of FIG. 8, the computing device(s) 800 includes or hosts the digital media management system 104 and/or the hierarchical segmentation system 102. Furthermore, as shown in FIG. 8, the hierarchical segmentation system 102 includes a digital image manager 802, a pseudo-label generator 804, a hierarchical segmentation manager 806, a training manager 808, and a storage manager 810.

As shown in FIG. 8, the hierarchical segmentation system 102 includes a digital image manager 802. In some implementations, the digital image manager 802 obtains one or more digital images for entity segmentation. Moreover, in some implementations, the digital image manager 802 obtains one or more batches of training images for training machine learning models (such as a segmentation model).

In addition, as shown in FIG. 8, the hierarchical segmentation system 102 includes a pseudo-label generator 804. In some implementations, the pseudo-label generator 804 generates pseudo-labels for one or more digital images. For instance, the pseudo-label generator 804 utilizes an encoder neural network to extract features for the digital images, clusters patches of pixels of the digital images into segmentation masks, and determines hierarchical relations for the segmentation masks to generate the pseudo-labels. In some embodiments, the pseudo-label generator 804 shares the pseudo-labels with a segmentation model for training of the segmentation model.

Moreover, as shown in FIG. 8, the hierarchical segmentation system 102 includes a hierarchical segmentation manager 806. In some implementations, the hierarchical segmentation manager 806 generates hierarchical segmentations for digital images. For example, the hierarchical segmentation manager 806 utilizes a segmentation model to segment entities of a digital image and determine hierarchical relations for the entities. Moreover, in some implementations, the hierarchical segmentation manager 806 generates a segmentation map comprising the entities of the digital image with indications of hierarchical relations between the entities.

Furthermore, as shown in FIG. 8, the hierarchical segmentation system 102 includes a training manager 808. In some implementations, the training manager 808 trains (e.g., modifies parameters of) one or more machine learning models, as described above, including the segmentation model 114. For instance, the training manager 808 utilizes pseudo-labels to train the segmentation model 114 to generate hierarchical segmentations for object entities of digital images. Moreover, in some implementations, the training manager 808 utilizes a trained segmentation model to initialize a teacher-student segmentation model and train the teacher-student segmentation model to improve over the segmentation model.

Additionally, as shown in FIG. 8, the hierarchical segmentation system 102 includes a storage manager 810. In some implementations, the storage manager 810 stores information (e.g., via one or more memory devices) on behalf of the hierarchical segmentation system 102. For example, the storage manager 810 stores digital images, pseudo-labels, parameters of one or more machine learning models (e.g., the segmentation model 114 and/or updated parameters of the teacher-student segmentation model), and segmentation maps for object entities of digital images.

Each of the components 802-810 of the hierarchical segmentation system 102 includes software, hardware, or both. For example, the components 802-810 includes one or more instructions stored on a computer-readable storage medium and executable by processors of one or more computing devices, such as a client device or server device. When executed by the one or more processors, the computer-executable instructions of the hierarchical segmentation system 102 cause the computing device(s) to perform the methods described herein. Alternatively, the components 802-810 include hardware, such as a special purpose processing device to perform a certain function or group of functions. Alternatively, the components 802-810 of the hierarchical segmentation system 102 include a combination of computer-executable instructions and hardware.

Furthermore, the components 802-810 of the hierarchical segmentation system 102 may, for example, be implemented as one or more operating systems, as one or more stand-alone applications, as one or more modules of an application, as one or more plug-ins, as one or more library functions or functions called by other applications, and/or as a cloud-computing model. Thus, in various embodiments, the components 802-810 are implemented as a stand-alone application, such as a desktop or mobile application. Furthermore, in some embodiments, the components 802-810 are implemented as one or more web-based applications hosted on a remote server. In some embodiments, the components 802-810 are implemented in a suite of mobile device applications or “apps.” To illustrate, in some embodiments, the components 802-810 are implemented in an application, including but not limited to Adobe Creative Cloud, Adobe Lightroom, Adobe Photoshop, Adobe Prelude, and Adobe Premiere. The foregoing are either registered trademarks or trademarks of Adobe in the United States and/or other countries.

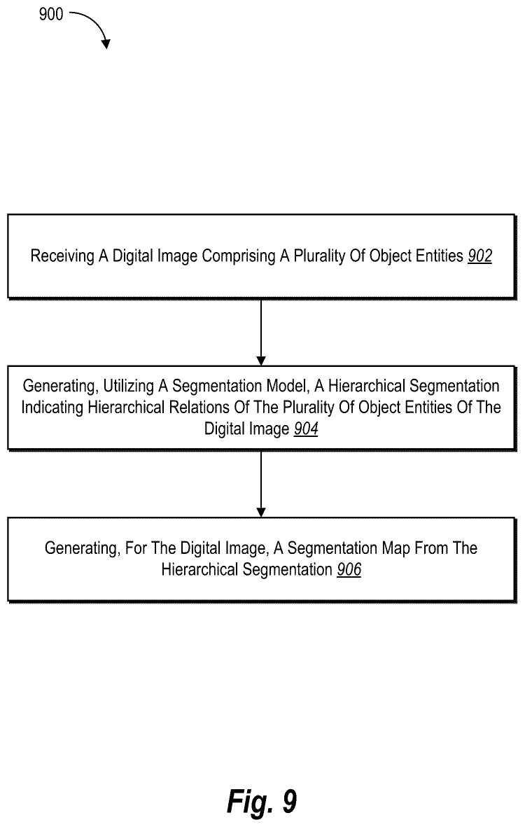

FIGS. 1-8, the corresponding text, and the examples provide a number of different methods, systems, devices, and non-transitory computer-readable media of the hierarchical segmentation system 102. In addition to the foregoing, one or more embodiments are described in terms of flowcharts comprising acts for accomplishing a particular result, as shown in FIG. 9. FIG. 9 are performed with more or fewer acts. Further, the acts are performed in differing orders. Additionally, in some embodiments, the acts described herein are repeated or performed in parallel with one another or parallel with different instances of the same or similar acts.

As mentioned, FIG. 9 illustrates a flowchart of a series of acts 900 for hierarchical entity segmentation in accordance with one or more implementations. While FIG. 9 illustrates acts according to one implementation, alternative implementations omit, add to, reorder, and/or modify any of the acts shown in FIG. 9. In one or more embodiments, the acts of FIG. 9 are performed as part of a method. Alternatively, a non-transitory computer-readable storage medium comprises instructions that, when executed by one or more processors, cause a computing device to perform the acts of FIG. 9. In some implementations, a system performs the acts of FIG. 9.

As shown in FIG. 9, the series of acts 900 includes an act 902 of receiving a digital image comprising a plurality of object entities, an act 904 of generating, utilizing a segmentation model, a hierarchical segmentation indicating hierarchical relations of the plurality of object entities of the digital image, and an act 906 of generating, for the digital image, a segmentation map from the hierarchical segmentation.

In particular, in some implementations, the act 902 includes receiving a digital image comprising a plurality of object entities, the act 904 includes generating, utilizing a segmentation model comprising parameters generated according to pseudo-labels indicating hierarchies of segmentation masks for a set of training digital images, a hierarchical segmentation indicating hierarchical relations of the plurality of object entities of the digital image, and the act 906 includes generating, for the digital image, a segmentation map from the hierarchical segmentation of the plurality of object entities.

For example, in some implementations, the series of acts 900 includes generating the hierarchical segmentation by: generating, utilizing a segmentation head of the segmentation model, predicted segmentation masks for the plurality of object entities of the digital image; and generating, utilizing an ancestor prediction head of the segmentation model, predicted hierarchical relations among the predicted segmentation masks. In addition, in some implementations, the series of acts 900 includes generating the predicted hierarchical relations among the segmentation masks by determining linear transformations for the segmentation masks.

Moreover, in some implementations, the series of acts 900 includes initializing a teacher-student segmentation model with the parameters of the segmentation model; generating, utilizing a teacher branch of the teacher-student segmentation model, a first predicted hierarchical segmentation of object entities of a first digital image; generating, utilizing a student branch of the teacher-student segmentation model, a second predicted hierarchical segmentation of object entities of a second digital image; and updating parameters of the teacher-student segmentation model based on the first predicted hierarchical segmentation of the object entities of the first digital image and the second predicted hierarchical segmentation of the object entities of the second digital image.

Furthermore, in some implementations, the series of acts 900 includes generating, utilizing the student branch of the teacher-student segmentation model, a third predicted hierarchical segmentation of the object entities of the first digital image; determining a first measure of loss between the first predicted hierarchical segmentation and the third predicted hierarchical segmentation; determining initial pseudo-labels indicating hierarchical segmentations of the object entities of the second digital image; and determining a second measure of loss between the second predicted hierarchical segmentation and the initial pseudo-labels, wherein updating the parameters of the teacher-student segmentation model comprises modifying the parameters of the teacher-student segmentation model based on the first measure of loss and the second measure of loss.

Moreover, in some implementations, the series of acts 900 includes generating, for the plurality of object entities of the digital image, initial pseudo-labels indicating initial segmentations and hierarchical relations among the plurality of object entities based on feature vectors of the digital image; and determining the hierarchies of segmentation masks for generating the parameters of the segmentation model based on the initial pseudo-labels.

Moreover, in some implementations, the series of acts 900 includes generating the hierarchical segmentation by: generating, utilizing a segmentation head of the segmentation model, predicted segmentation masks for the plurality of object entities of the digital image; determining, utilizing an ancestor prediction head of the segmentation model, a linear transformation for the predicted segmentation masks; and determining, from the linear transformation, predicted hierarchical relations among the predicted segmentation masks.

In addition, in some implementations, the series of acts 900 includes extracting, utilizing an encoder neural network, features representing the digital image; and generating, for the plurality of object entities of the digital image, initial pseudo-labels indicating initial segmentations and hierarchical relations among the plurality of object entities based on the features representing the digital image.

Furthermore, in some implementations, the series of acts 900 includes initializing a teacher-student segmentation model with the parameters of the segmentation model; generating, utilizing a teacher branch of the teacher-student segmentation model, a first predicted hierarchical segmentation of object entities of a first digital image; determining initial pseudo-labels indicating hierarchical segmentations of object entities of a second digital image; generating, utilizing a student branch of the teacher-student segmentation model, a second predicted hierarchical segmentation of the object entities of the second digital image and a third predicted hierarchical segmentation of the object entities of the first digital image; and updating parameters of the teacher-student segmentation model based on the first predicted hierarchical segmentation, the second predicted hierarchical segmentation, the third predicted hierarchical segmentation, and the initial pseudo-labels.

Moreover, in some implementations, the series of acts 900 includes updating the parameters of the teacher-student segmentation model by: modifying parameters of the student branch utilizing an optimization routine based on the first predicted hierarchical segmentation, the second predicted hierarchical segmentation, the third predicted hierarchical segmentation, and the initial pseudo-labels; and modifying parameters of the teacher branch utilizing a moving average based on the parameters of the student branch.

Alternatively, in some implementations, the series of acts 900 includes extracting, utilizing an encoder neural network, features representing a digital image; generating, for the digital image, pseudo-labels indicating segmentations of object entities of the digital image and a hierarchical segmentation indicating hierarchical relations among the object entities based on the features; and generating, utilizing a segmentation model comprising parameters generated according to the pseudo-labels, a segmentation map comprising a predicted hierarchical segmentation of the object entities of the digital image.

For example, in some implementations, the series of acts 900 includes extracting the features representing the digital image by: determining a plurality of patches of pixels within the digital image; and extracting, for each patch of the plurality of patches, a feature vector representing visual features of the pixels within the patch. In addition, in some implementations, the series of acts 900 includes generating the pseudo-labels by: merging at least some of the plurality of patches into a first group of clusters based on similarities of the features at a first merging threshold; and determining mask hierarchies of the object entities within the digital image from the first group of clusters.

Moreover, in some implementations, the series of acts 900 includes generating the pseudo-labels further by: merging at least some of the plurality of patches into a second group of clusters based on similarities of the features at a second merging threshold; combining the first group of clusters and the second group of clusters into a pool of regions; determining a modified pool of regions by removing duplicate regions from the pool of regions; and determining the mask hierarchies of the object entities within the digital image based on the modified pool of regions.

Furthermore, in some implementations, the series of acts 900 includes selecting a subset of regions from the pool of regions, wherein each region of the subset of regions is smaller than a predetermined threshold percentage of the digital image; cropping, for each region of the subset of regions, a local image from the digital image; merging at least some of the plurality of patches within the local image into a reclustered pool of regions based on similarities of the features of the patches within the local image; and determining the mask hierarchies of the object entities within the digital image based on the reclustered pool of regions.

Moreover, in some implementations, the series of acts 900 includes generating the segmentation map by determining the predicted hierarchical segmentation of the object entities of the digital image by: generating, utilizing a segmentation head comprising a transformer-based encoder neural network, predicted segmentation masks for the object entities of the digital image; and generating, utilizing an ancestor prediction head, predicted hierarchical relations among the predicted segmentation masks of the object entities. In addition, in some implementations, the series of acts 900 includes generating the predicted hierarchical relations among the predicted segmentation masks by generating a linear transformation matrix for the predicted segmentation masks based on a set of query features.

Moreover, in some implementations, the series of acts 900 includes initializing a teacher-student segmentation model with the parameters of the segmentation model, the teacher-student segmentation model comprising a teacher branch and a student branch; and updating parameters of the teacher-student segmentation model based on the pseudo-labels and labels generated by the teacher branch. Furthermore, in some implementations, the series of acts 900 includes updating the parameters of the teacher-student segmentation model by: generating teacher pseudo-labels indicating hierarchical segmentations of object entities of a first digital image utilizing the teacher branch; generating a first predicted hierarchical segmentation of the object entities of the first digital image utilizing the student branch; generating a second predicted hierarchical segmentation of object entities of a second digital image utilizing the student branch; generating initial pseudo-labels indicating hierarchical segmentations of object entities of the second digital image; and determining a measure of loss based on the teacher pseudo-labels, the first predicted hierarchical segmentation, the second predicted hierarchical segmentation, and the initial pseudo-labels.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000, may represent the computing devices described above (e.g., the computing device(s) 800, the server device(s) 106, or the client device 108). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes the memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes the storage device 1006 for storing data or instructions. As an example, and not by way of limitation, the storage device 1006 can include a non-transitory storage medium described above. The storage device 1006 may include a hard disk drive (“HDD”), flash memory, a Universal Serial Bus (“USB”) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include the bus 1012. The bus 1012 can include hardware, software, or both that connects components of computing device 1000 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a digital image comprising a plurality of object entities;
generating, utilizing a segmentation model comprising parameters generated according to pseudo-labels indicating hierarchies of segmentation masks for a set of training digital images, a hierarchical segmentation indicating hierarchical relations of the plurality of object entities of the digital image; and
generating, for the digital image, a segmentation map from the hierarchical segmentation of the plurality of object entities.

2. The computer-implemented method of claim 1, wherein generating the hierarchical segmentation comprises:
generating, utilizing a segmentation head of the segmentation model, predicted segmentation masks for the plurality of object entities of the digital image; and
generating, utilizing an ancestor prediction head of the segmentation model, predicted hierarchical relations among the predicted segmentation masks.

3. The computer-implemented method of claim 2, wherein generating the predicted hierarchical relations among the segmentation masks comprises determining linear transformations for the segmentation masks.

4. The computer-implemented method of claim 1, further comprising:
initializing a teacher-student segmentation model with the parameters of the segmentation model;
generating, utilizing a teacher branch of the teacher-student segmentation model, a first predicted hierarchical segmentation of object entities of a first digital image;
generating, utilizing a student branch of the teacher-student segmentation model, a second predicted hierarchical segmentation of object entities of a second digital image; and
updating parameters of the teacher-student segmentation model based on the first predicted hierarchical segmentation of the object entities of the first digital image and the second predicted hierarchical segmentation of the object entities of the second digital image.

5. The computer-implemented method of claim 4, further comprising:
generating, utilizing the student branch of the teacher-student segmentation model, a third predicted hierarchical segmentation of the object entities of the first digital image;
determining a first measure of loss between the first predicted hierarchical segmentation and the third predicted hierarchical segmentation;
determining initial pseudo-labels indicating hierarchical segmentations of the object entities of the second digital image; and
determining a second measure of loss between the second predicted hierarchical segmentation and the initial pseudo-labels,
wherein updating the parameters of the teacher-student segmentation model comprises modifying the parameters of the teacher-student segmentation model based on the first measure of loss and the second measure of loss.

6. The computer-implemented method of claim 1, further comprising:
generating, for the plurality of object entities of the digital image, initial pseudo-labels indicating initial segmentations and hierarchical relations among the plurality of object entities based on feature vectors of the digital image; and
determining the hierarchies of segmentation masks for generating the parameters of the segmentation model based on the initial pseudo-labels.

7. A system comprising:
one or more memory devices; and
one or more processors coupled to the one or more memory devices that cause the system to perform operations comprising:
extracting, utilizing an encoder neural network, features representing a digital image;
generating, for the digital image, pseudo-labels indicating segmentations of object entities of the digital image and a hierarchical segmentation indicating hierarchical relations among the object entities based on the features; and
generating, utilizing a segmentation model comprising parameters generated according to the pseudo-labels, a segmentation map comprising a predicted hierarchical segmentation of the object entities of the digital image.

8. The system of claim 7, wherein extracting the features representing the digital image comprises:
determining a plurality of patches of pixels within the digital image; and
extracting, for each patch of the plurality of patches, a feature vector representing visual features of the pixels within the patch.

9. The system of claim 8, wherein generating the pseudo-labels comprises:
merging at least some of the plurality of patches into a first group of clusters based on similarities of the features at a first merging threshold; and
determining mask hierarchies of the object entities within the digital image from the first group of clusters.

10. The system of claim 9, wherein generating the pseudo-labels further comprises:
merging at least some of the plurality of patches into a second group of clusters based on similarities of the features at a second merging threshold;
combining the first group of clusters and the second group of clusters into a pool of regions;
determining a modified pool of regions by removing duplicate regions from the pool of regions; and
determining the mask hierarchies of the object entities within the digital image based on the modified pool of regions.

11. The system of claim 10, wherein the one or more processors further cause the system to perform operations comprising:
selecting a subset of regions from the pool of regions, wherein each region of the subset of regions is smaller than a predetermined threshold percentage of the digital image;
cropping, for each region of the subset of regions, a local image from the digital image;
merging at least some of the plurality of patches within the local image into a reclustered pool of regions based on similarities of the features of the patches within the local image; and
determining the mask hierarchies of the object entities within the digital image based on the reclustered pool of regions.

12. The system of claim 7, wherein generating the segmentation map comprises determining the predicted hierarchical segmentation of the object entities of the digital image by:
generating, utilizing a segmentation head comprising a transformer-based encoder neural network, predicted segmentation masks for the object entities of the digital image; and
generating, utilizing an ancestor prediction head, predicted hierarchical relations among the predicted segmentation masks of the object entities.

13. The system of claim 12, wherein generating the predicted hierarchical relations among the predicted segmentation masks comprises generating a linear transformation matrix for the predicted segmentation masks based on a set of query features.

14. The system of claim 7, wherein the one or more processors further cause the system to perform operations comprising:
initializing a teacher-student segmentation model with the parameters of the segmentation model, the teacher-student segmentation model comprising a teacher branch and a student branch; and
updating parameters of the teacher-student segmentation model based on the pseudo-labels and labels generated by the teacher branch.

15. The system of claim 14, wherein updating the parameters of the teacher-student segmentation model comprises:
generating teacher pseudo-labels indicating hierarchical segmentations of object entities of a first digital image utilizing the teacher branch;
generating a first predicted hierarchical segmentation of the object entities of the first digital image utilizing the student branch;
generating a second predicted hierarchical segmentation of object entities of a second digital image utilizing the student branch;
generating initial pseudo-labels indicating hierarchical segmentations of object entities of the second digital image; and
determining a measure of loss based on the teacher pseudo-labels, the first predicted hierarchical segmentation, the second predicted hierarchical segmentation, and the initial pseudo-labels.

16. A non-transitory computer-readable medium storing instructions thereon that, when executed by at least one processor, cause the at least one processor to perform operations comprising:
receiving a digital image comprising a plurality of object entities;
generating, utilizing a segmentation model comprising parameters generated according to pseudo-labels indicating hierarchies of segmentation masks for a set of training digital images, a hierarchical segmentation indicating hierarchical relations of the plurality of object entities of the digital image; and
generating, for the digital image, a segmentation map from the hierarchical segmentation of the plurality of object entities.

17. The non-transitory computer-readable medium of claim 16, wherein generating the hierarchical segmentation comprises:
generating, utilizing a segmentation head of the segmentation model, predicted segmentation masks for the plurality of object entities of the digital image;
determining, utilizing an ancestor prediction head of the segmentation model, a linear transformation for the predicted segmentation masks; and
determining, from the linear transformation, predicted hierarchical relations among the predicted segmentation masks.

18. The non-transitory computer-readable medium of claim 16, further storing instructions thereon that, when executed by the at least one processor, cause the at least one processor to perform operations comprising:
extracting, utilizing an encoder neural network, features representing the digital image; and
generating, for the plurality of object entities of the digital image, initial pseudo-labels indicating initial segmentations and hierarchical relations among the plurality of object entities based on the features representing the digital image.

19. The non-transitory computer-readable medium of claim 16, further storing instructions thereon that, when executed by the at least one processor, cause the at least one processor to perform operations comprising:
initializing a teacher-student segmentation model with the parameters of the segmentation model;
generating, utilizing a teacher branch of the teacher-student segmentation model, a first predicted hierarchical segmentation of object entities of a first digital image;
determining initial pseudo-labels indicating hierarchical segmentations of object entities of a second digital image;
generating, utilizing a student branch of the teacher-student segmentation model, a second predicted hierarchical segmentation of the object entities of the second digital image and a third predicted hierarchical segmentation of the object entities of the first digital image; and
updating parameters of the teacher-student segmentation model based on the first predicted hierarchical segmentation, the second predicted hierarchical segmentation, the third predicted hierarchical segmentation, and the initial pseudo-labels.

20. The non-transitory computer-readable medium of claim 19, wherein updating the parameters of the teacher-student segmentation model comprises:
modifying parameters of the student branch utilizing an optimization routine based on the first predicted hierarchical segmentation, the second predicted hierarchical segmentation, the third predicted hierarchical segmentation, and the initial pseudo-labels; and
modifying parameters of the teacher branch utilizing a moving average based on the parameters of the student branch.
